(19) United States
(12) Patent Application Publication
(10) Pub. No.: US 2017/0105580 A1
(43) Pub. Date: Apr. 20, 2017

(54) Food Preparation Pan and Scale

(71) Applicant: Peter Anthony Alevras, Carpentersville, IL (US)

(72) Inventor: Peter Anthony Alevras, Carpentersville, IL (US)

(21) Appl. No.: 14/885,125

(22) Filed: Oct. 16, 2015

(51) Int. Cl. A47J 43/18; A47J 37/04

(52) U.S. Cl. CPC A47J 43/18; A47J 37/043

(57) ABSTRACT

A pan for a vertical rotisserie is disclosed. The pan includes a pan body having a semicircle portion and a crescent portion, a handle, and a weight measurement device. The pan body has a second open end defining a pan profile. Advantageously, the pan of the present disclosure allows a cook to, simultaneously, shave portions of meat from the rotisserie while weighing the amount of meat collected in the pan. A pan of the present disclosure allows a shaving step and a weighing step to be completed simultaneously, thereby saving significant time and providing an easier process for a cook to accomplish such tasks.

### BACKGROUND OF THE INVENTION

1. Field of the Disclosure

The present disclosure relates generally to food preparation pans, and more particularly to a food preparation pan for a vertical rotisserie that includes a weight measurement device.

2. Description of the Related Art

Rotisserie devices comprising a vertical rotatable spit are commonly used in restaurants to roast food products, typically meat. These rotisserie devices generally comprise a vertical rotatable spit, on which meat is skewered to form a stacked meat piling. Rotisserie devices also include heating elements located adjacent the rotatable spit. In use, once the meat has been skewered on the spit, the heating elements are adjusted to release a selected amount of heat, and the spit is slowly rotated adjacent the heating elements to cook the meat. Such rotisserie devices are typically used in specialty restaurants, of the type serving Gyro-style or Shish-Taouk style meat sandwiches, for example.

When it is desired to prepare a meat serving from the meat on the vertical rotisserie, a cook or food preparer uses a sharp knife to shave or carve thin portions of meat from the body of the meat on the vertical rotisserie. It is important in the food industry to provide an accurate portion of the product. Conventional methods include shaving portions of meat from the rotisserie and then, in a separate step, having to move the shaved meat to a scale to weigh the amount of meat collected. If not enough meat is present, a cook must then go back to the rotisserie and shave additional meat from the rotisserie and repeat the weighing step. This step may need to be repeated many times before an accurate portion of the product is obtained. Conventional methods and cooking equipment can lead to a significant loss of time and undue burden on cooks in preparing food products.

### SUMMARY OF THE INVENTION

The present disclosure provides a pan for a vertical rotisserie. The pan includes a pan body having a semicircle portion and a crescent portion, a handle, and a weight measurement device. The pan body has a second open end defining a pan profile. Advantageously, the pan of the present disclosure allows a cook to, simultaneously, shave portions of meat from the rotisserie while weighing the amount of meat collected in the pan. A pan of the present disclosure allows a shaving step and a weighing step to be completed simultaneously, thereby saving significant time and providing an easier process for a cook to accomplish such tasks.

In accordance with an embodiment of the present invention, a pan for a vertical rotisserie includes a pan body having a semicircle portion and a crescent portion, the pan body having a bottom, a sidewall extending upwardly from a portion of the periphery of the bottom, a first end, and a second end, the second end being open, and the second end defining a pan profile; a handle extending outward from the first end; a weight measurement device disposed within a portion of the handle; and a digital display in communication with the weight measurement device, the digital display located on a top portion of the handle.

In one configuration, a portion of the second end of the pan body curves inward toward the first end. In another configuration, the pan profile is shaped to substantially correspond to an exterior profile of the vertical rotisserie. In one configuration, the second end of the pan body includes a ribbed surface. In yet another configuration, the pan further includes a connector having a first portion and a second portion, the first portion secured to the pan body and the second portion secured to the handle, wherein the first portion of the connector is secured to the pan body by three fasteners. In another configuration, the weight measurement device includes a load sensor. In yet another configuration, the weight measurement device includes a printed circuit board. In one configuration, the weight measurement device is battery powered. In another configuration, the digital display includes a liquid crystal display. In yet another configuration, the pan includes a mode button selectable between a milliliter setting, a pound setting, a gram setting, and an ounce setting. In one configuration, the handle includes a first handle portion and a second handle portion, the first handle portion including a plurality of alignment posts and the second handle portion including a plurality of receiving members, with the first handle portion secured to the second handle portion, the alignment posts are received within the respective receiving members, and with the first handle portion secured to the second handle portion, a cavity is defined within the handle and the weight measurement device is disposed within the cavity. In another configuration, the pan further includes a cutting element removably attachable to the second end of the pan body. In yet another configuration, a portion of the second end of the pan body includes a cutting element. In one configuration, the pan further includes a gripping area on a portion of the handle.

In accordance with another embodiment of the present invention, a pan for a vertical rotisserie includes a pan body having a semicircle portion and a crescent portion, the pan body having a bottom, a sidewall extending upwardly from a portion of the periphery of the bottom, a first end, and a second end, the second end being open, the second end defining a pan profile, and the pan profile shaped to substantially correspond to an exterior profile of the vertical rotisserie; a handle extending outward from the first end; a connector having a first portion and a second portion, the first portion secured to the pan body and the second portion secured to the handle; a weight measurement device disposed within a portion of the handle; and a digital display in communication with the weight measurement device, the digital display located on a top portion of the handle, wherein the pan includes a mode button selectable between a milliliter setting, a pound setting, a gram setting, and an ounce setting, and wherein the handle includes a first handle portion and a second handle portion, the first handle portion including a plurality of alignment posts and the second handle portion including a plurality of receiving members, with the first handle portion secured to the second handle portion, the alignment posts are received within the respective receiving members, and with the first handle portion secured to the second handle portion, a cavity is defined within the handle and the weight measurement device is disposed within the cavity.

In one configuration, the pan further includes a gripping area on a portion of the handle. In another configuration, the weight measurement device includes a load sensor. In yet another configuration, the pan further includes a cutting element removably attachable to the second end of the pan body. In one configuration, a portion of the second end of the pan body includes a cutting element.

In accordance with another embodiment of the present invention, a food preparation system includes a vertical rotisserie having a foodstuff thereon, the foodstuff defining an exterior profile; and a pan includes a pan body having a semicircle portion and a crescent portion, the pan body having a bottom, a sidewall extending upwardly from a portion of the periphery of the bottom, a first end, and a second end, the second end being open, the second end defining a pan profile, and the pan profile shaped to substantially correspond to the exterior profile; a handle extending outward from the first end; a weight measurement device disposed within a portion of the handle; and a digital display in communication with the weight measurement device, the digital display located on a top portion of the handle.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1 is a perspective view of a pan for a vertical rotisserie in accordance with an embodiment of the present invention.

FIG. 2 is a perspective view of a first step of using a pan of the present disclosure in accordance with an embodiment of the present invention

FIG. 3 is a perspective view of a second step of using a pan of the present disclosure in accordance with an embodiment of the present invention.

FIG. 4 is a perspective view of a third step of using a pan of the present disclosure in accordance with an embodiment of the present invention.

FIG. 5 is an exploded, perspective view of a pan in accordance with an embodiment of the present invention.

FIG. 6 is a side elevation view of a handle in accordance with an embodiment of the present invention.

FIG. 7 is a fragmentary perspective view of a connector having a portion secured to a pan body and a portion secured to a handle in accordance with an embodiment of the present invention.

FIG. 8 is a second fragmentary perspective view of a connector having a portion secured to a pan body and a portion secured to a handle in accordance with an embodiment of the present invention.

FIG. 9 is a perspective view of a pan for a vertical rotisserie with a removably attachable cutting element in accordance with an embodiment of the present invention.

FIG. 10 is a cross-sectional view of a cutting element engaged with a pan in accordance with another embodiment of the present invention.

FIG. 11 is a cross-sectional view of a cutting element disengaged with a pan in accordance with another embodiment of the present invention.

FIG. 12 is a perspective view of a pan for a vertical rotisserie with a cutting element in accordance with another embodiment of the present invention.

FIG. 13 is a cross-sectional view of a cutting element of a pan in accordance with another embodiment of the present invention.

FIG. 14 is a cross-sectional view of a cutting element of a pan with a cover shielding the cutting element in accordance with another embodiment of the present invention.

FIG. 15 is a perspective view of a first step of using a pan of the present disclosure in accordance with another embodiment of the present invention

FIG. 16 is a perspective view of a second step of using a pan of the present disclosure in accordance with another embodiment of the present invention.

FIG. 17 is a perspective view of a pan for a vertical rotisserie including a ribbed surface in accordance with an embodiment of the present invention.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

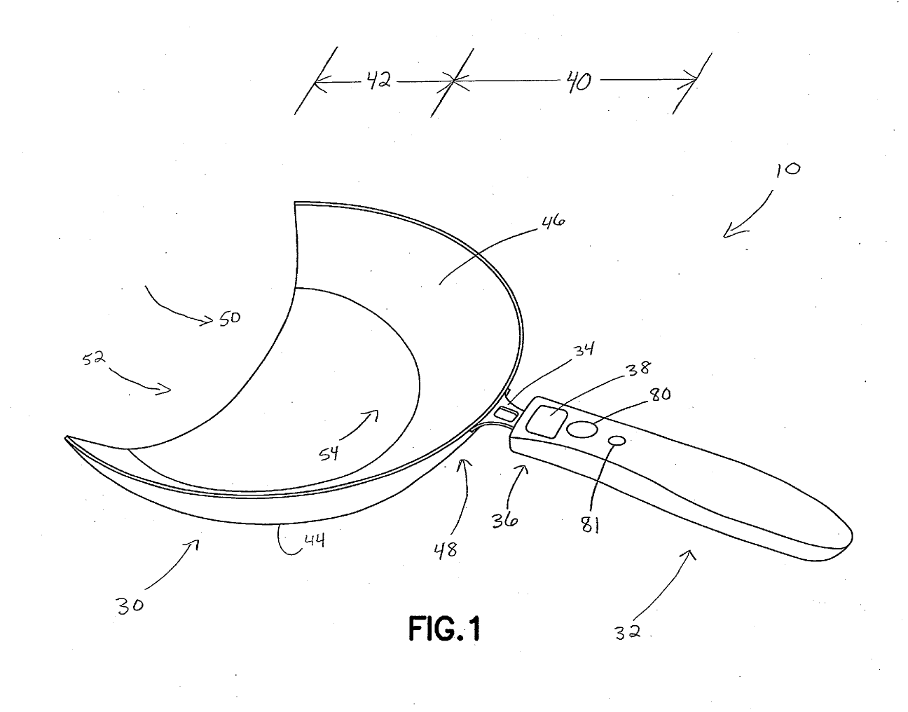

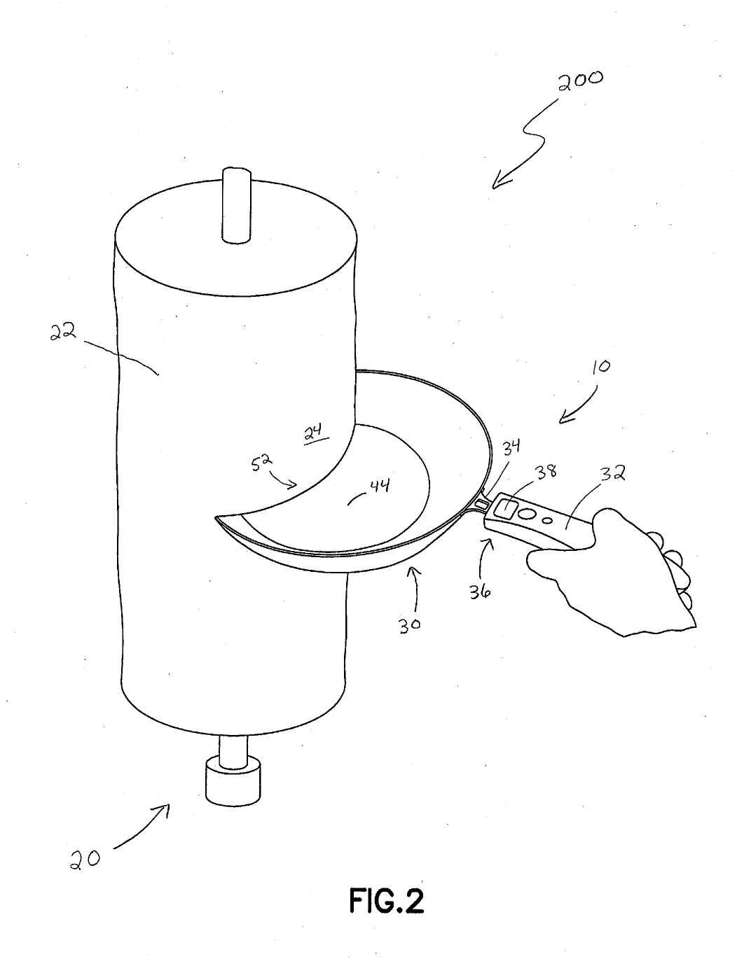

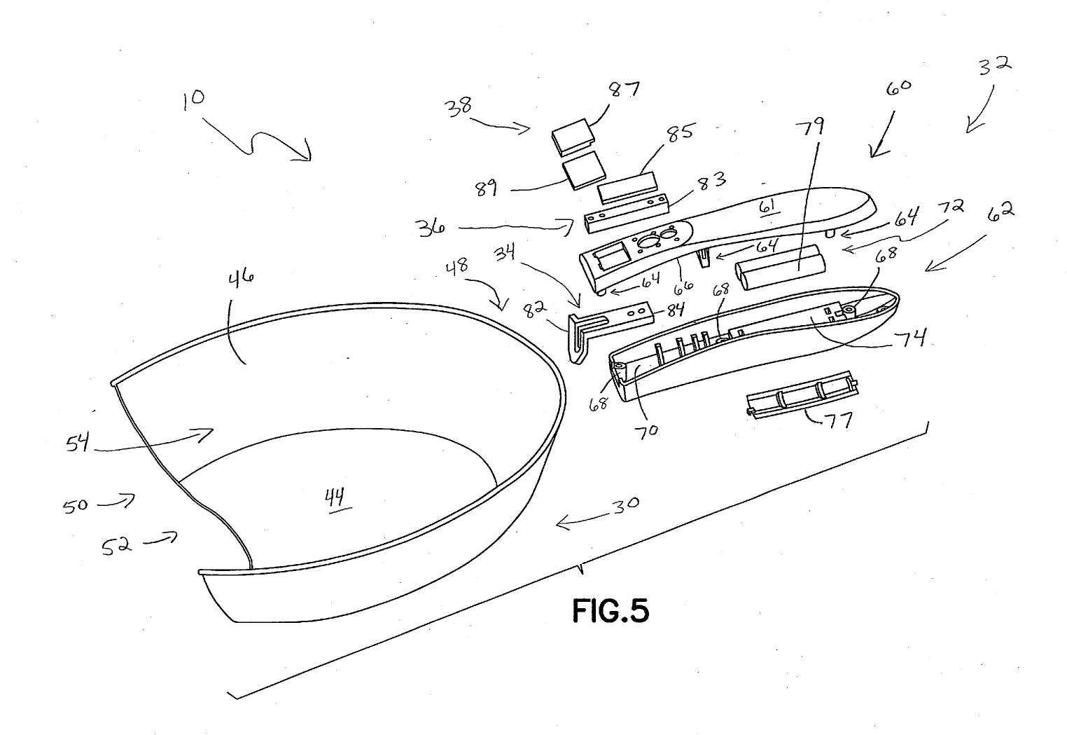

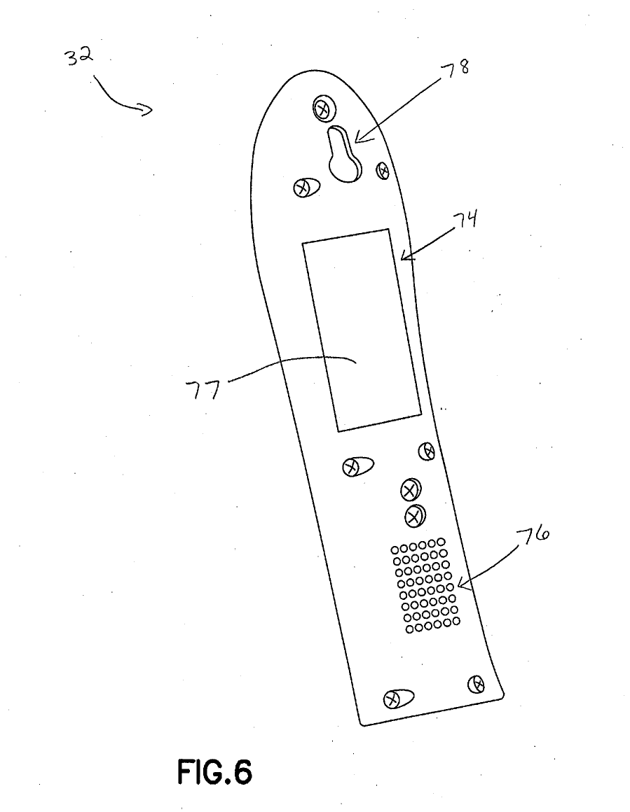

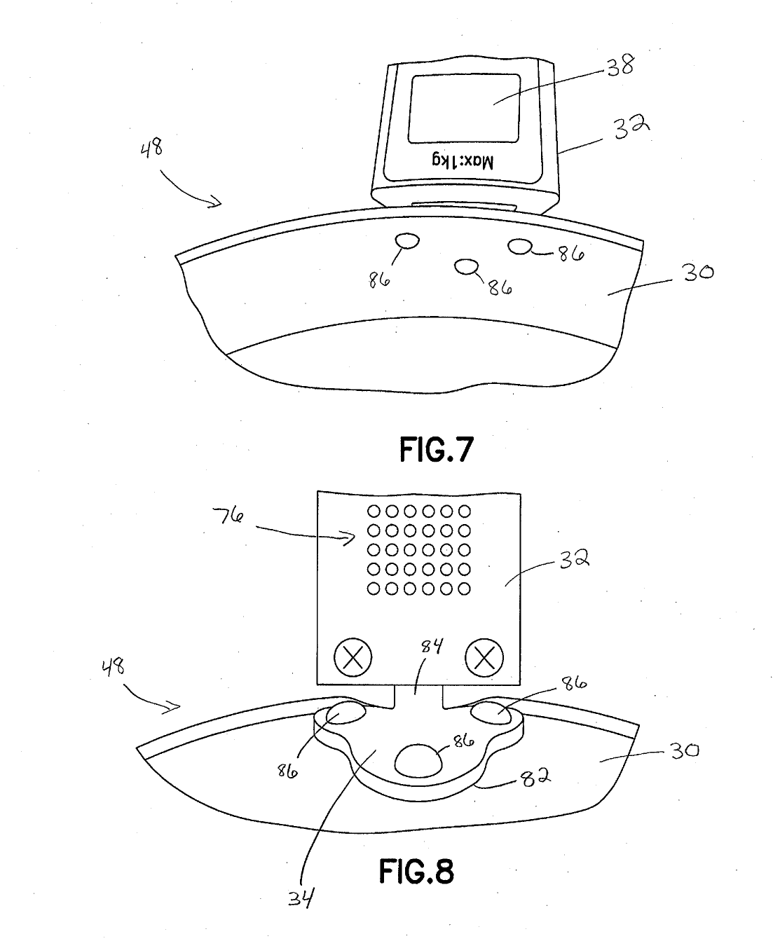

FIGS. 1-8 illustrate an exemplary embodiment of a pan of the present disclosure. In one embodiment, a pan 10 of the present disclosure is compatible with a vertical rotisserie 20. For example, referring to FIGS. 2-4, a pan 10 is positionable adjacent to and in contact with a vertical rotisserie 20 for shaving portions of meat 22 from the vertical rotisserie 20 onto the pan 10. The pan 10 of the present disclosure includes a weight measurement device 36. Advantageously, the pan 10 of the present disclosure allows a cook to, simultaneously, shave portions of meat 22 from the rotisserie 20 while weighing the amount of meat 22 collected in the pan 10. A pan 10 of the present disclosure allows a shaving step and a weighing step to be completed simultaneously, thereby saving significant time and providing an easier process for a cook to accomplish such tasks.

The pan 10 of the present disclosure is also compatible with other rotisseries. For example, the pan 10 of the present disclosure is compatible with horizontal rotisseries and vertical rotisseries.

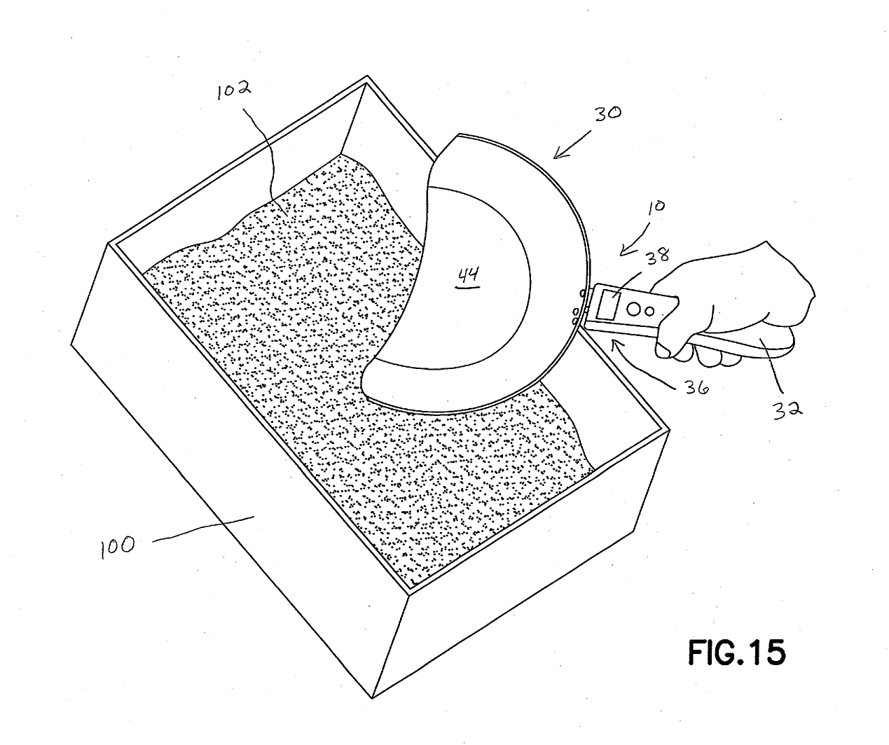

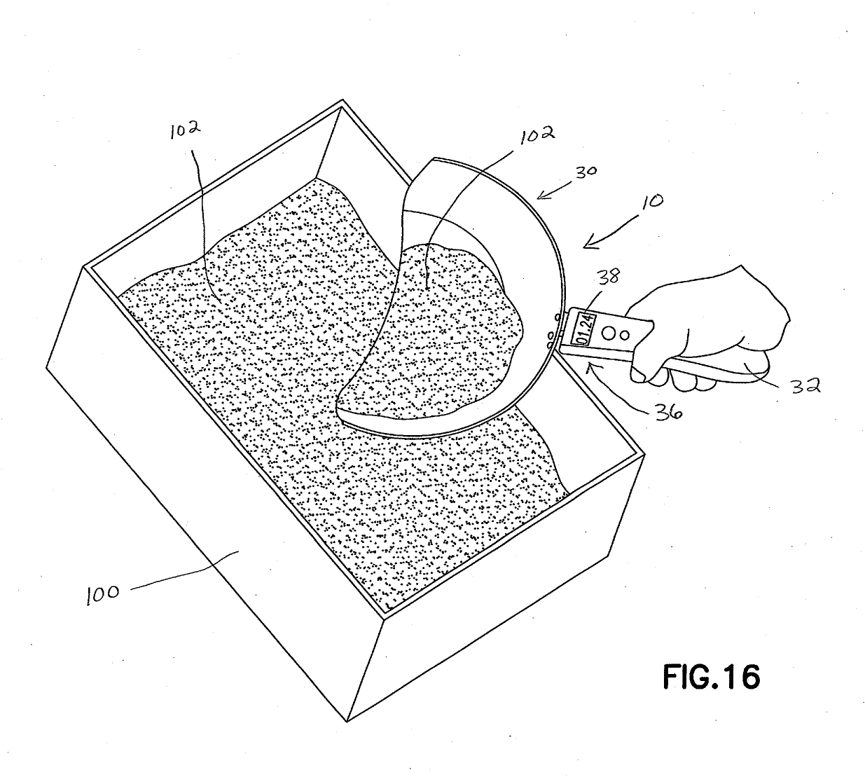

In another embodiment, a pan 10 of the present disclosure is compatible with a container 100 holding a cooking ingredient 102. For example, referring to FIGS. 15-16, a pan 10 is positionable within a container 100 for scooping out a portion of a cooking ingredient 102 onto the pan 10. The pan 10 of the present disclosure includes a weight measurement device 36. Advantageously, the pan 10 of the present disclosure allows a cook to, simultaneously, scoop out a portion of a cooking ingredient 102 from the container 100 while weighing the amount of cooking ingredient 102 collected in the pan 10. A pan 10 of the present disclosure allows a scooping step and a weighing step to be completed simultaneously, thereby saving significant time and providing an easier process for a cook to accomplish such tasks.

Referring to FIGS. 1-8, in one embodiment, a pan 10 of the present disclosure includes a pan body 30, a handle 32, a connector 34, a weight measurement device 36, and a digital display 38. In one embodiment, the pan body 30 includes a semicircle portion 40 and a crescent portion 42. For example, in one embodiment, the shape of the pan body 30 comprises the shape of the semicircle portion 40 together with the shape of the crescent portion 42. In one embodiment, the pan body 30 includes a bottom 44, a sidewall 46 extending upwardly from a portion of the periphery of the bottom 44, a first end 48, and a second end 50. The pan body 30 comprises a concave inner surface 54 into which a food or meat 22 can be received and held.

In one embodiment, the second end 50 is open, i.e., the second end 50 of pan body 30 does not have a sidewall 46 to allow the second end 50 of the pan 10 to be positionable adjacent and in contact with a vertical rotisserie 20 for shaving portions of meat 22 from the vertical rotisserie 20 onto the pan 10.

In one embodiment, the second end 50 defines a pan profile 52. In one embodiment, the pan profile 52 is shaped to substantially correspond to an exterior profile 24 of the vertical rotisserie 20. In this manner, the second end 50 of pan body 30 is positionable adjacent and in contact with a vertical rotisserie 20 for shaving portions of meat 22 from the vertical rotisserie 20 onto the pan 10.

In one embodiment, referring to FIG. 2, a portion of the second end 50 of the pan body 30 curves inward toward the first end 48. In this manner, the second end 50 of pan body 30 is positionable adjacent and in contact with a vertical rotisserie 20 for shaving portions of meat 22 from the vertical rotisserie 20 onto the pan 10.

In one embodiment, a weight measurement device 36 is disposed within a portion of the handle 32. Advantageously, the pan 10 having a weight measurement device 36 of the present disclosure allows a cook to, simultaneously, shave portions of meat 22 from the rotisserie 20 while weighing the amount of meat 22 collected in the pan 10. A pan 10 of the present disclosure allows a shaving step and a weighing step to be completed simultaneously, thereby saving significant time and providing an easier process for a cook to accomplish such tasks.

In one embodiment, the weight measurement device 36 includes a load sensor 83. In one embodiment, the weight measurement device 36 includes a printed circuit board 85. In one embodiment, the weight measurement device 36 is battery powered. In one embodiment, the weight measurement device 36 of the pan 10 of the present disclosure can be any device used to measure the weight of a food or meat received within the pan body 30. For example, the weight measurement device 36 of the pan 10 of the present disclosure may be any type of scale, load sensor, strain gauge, and/or other device.

Referring to FIGS. 1-8, the handle 32 extends outward from the first end 48 of the pan body 30. In one embodiment, the handle 32 includes a first handle portion 60 having a top surface 61 and a second handle portion 62. In one embodiment, the first handle portion 60 includes a plurality of alignment posts 64 extending from an inferior surface 66 of the first handle portion 60. In one embodiment, the second handle portion 62 includes a plurality of receiving members 68 extending from a bottom surface 70 of the second handle portion 62.

With the first handle portion 60 secured to the second handle portion 62, the alignment posts 64 are received within the respective receiving members 68 to securely lock the first handle portion 60 to the second handle portion 62. Additionally, with the first handle portion 60 secured to the second handle portion 62, a cavity 72 is defined within the handle 32 and the weight measurement device 36 is disposed within the cavity 72 of the handle 32.

The handle 32 also includes a battery compartment 74 for receiving batteries 79 (FIG. 5) to power a weight measurement device 36 of a pan 10 of the present disclosure. In one embodiment, the handle 32 includes a battery cover 77 for securely covering the batteries 79 within the battery compartment 74. A portion of the handle 32 includes a gripping area 76. The gripping area 76 can be included on any portion of the handle 32 for improving the grip between the handle 32 and a user's fingertips. The handle 32 may also include a hanging eyelet 78 to allow the pan 10 to be stored hanging from a wall or other surface.

In one embodiment, the pan 10 includes a digital display 38 in communication with the weight measurement device 36. In one embodiment, the digital display 38 is located on a top portion or top surface 61 of the first handle portion 60 of the handle 32. In one embodiment, the digital display 38 includes a liquid crystal display 87. The digital display 38 of the pan 10 of the present disclosure provides an easy to see visual display of a weight of the amount of meat 22 collected in the pan 10. In one embodiment, the digital display 38 of the handle 32 includes a backlight 89 (FIG. 5).

In one embodiment, the pan 10 includes a mode button 80 that is selectable between a milliliter setting, a pound setting, a gram setting, and an ounce setting. The mode button 80 may include any information and/or setting that a user desires to have displayed when using a pan 10 of the present disclosure to perform a shaving step and a weighing step to be completed simultaneously, thereby saving significant time and providing an easier process for a cook to accomplish such tasks. In one embodiment, the mode button 80 is located on a top portion or top surface 61 of the first handle portion 60 of the handle 32.

In one embodiment, the pan 10 includes an on/off button 81. In one embodiment, the on/off button 81 is located on a top portion or top surface 61 of the first handle portion 60 of the handle 32.

In one embodiment, the pan 10 includes a connector 34. In one embodiment, the connector 34 includes a first portion 82 and a second portion 84. The first portion 82 of the connector 34 may be secured to a portion of the first end 48 of the pan body 30 and the second portion 84 of the connector 34 may be secured to a portion of the handle 32. The connector 34 securely connects the pan body 30 and the handle 32.

In one embodiment, the first portion 82 of the connector 34 is secured to the pan body 30 by three fasteners 86. In another embodiment, any number of fasteners 86 may be used to secure the connector 34 to the pan body 30. In other embodiments, other securement mechanisms may be used to secure the connector 34 to the pan body 30.

Referring to FIGS. 1-8, use of a pan 10 of the present disclosure in accordance with an exemplary embodiment will now be described. In one embodiment, referring to FIG. 2, the pan 10 of the present disclosure may be positioned adjacent to and in contact with a vertical rotisserie 20 holding meat 22 to shave portions of meat 22 from the vertical rotisserie 20 onto the pan 10.

With the pan 10 contacting the vertical rotisserie 20, a cutting element, such as a sharp knife, may be used by a cook or food preparer to shave or carve thin portions of meat 22 from the vertical rotisserie 20 onto the pan 10. The pan 10 of the present disclosure includes a weight measurement device 36 as described above. Advantageously, the pan 10 of the present disclosure allows a cook to, simultaneously, shave portions of meat 22 from the rotisserie 20 to the pan 10 while weighing the amount of meat 22 collected in the pan 10. A pan 10 of the present disclosure allows a shaving step and a weighing step to be completed simultaneously, thereby saving significant time and providing an easier process for a cook to accomplish such tasks.

It is important in the food industry to provide an accurate portion of the product. Conventional methods include shaving portions of meat from the rotisserie and then, in a separate step, having to move the shaved meat to a scale to weigh the amount of meat collected. If not enough meat is present, a cook must then go back to the rotisserie and shave additional meat from the rotisserie and repeat the weighing step. This step may need to be repeated many times before an accurate portion of the product is obtained. Conventional methods and cooking equipment can lead to a significant loss of time and undue burden on cooks in preparing food products.

A pan 10 of the present disclosure allows a shaving step and a weighing step to be completed simultaneously, thereby saving significant time and providing an easier process for a cook to accomplish such tasks.

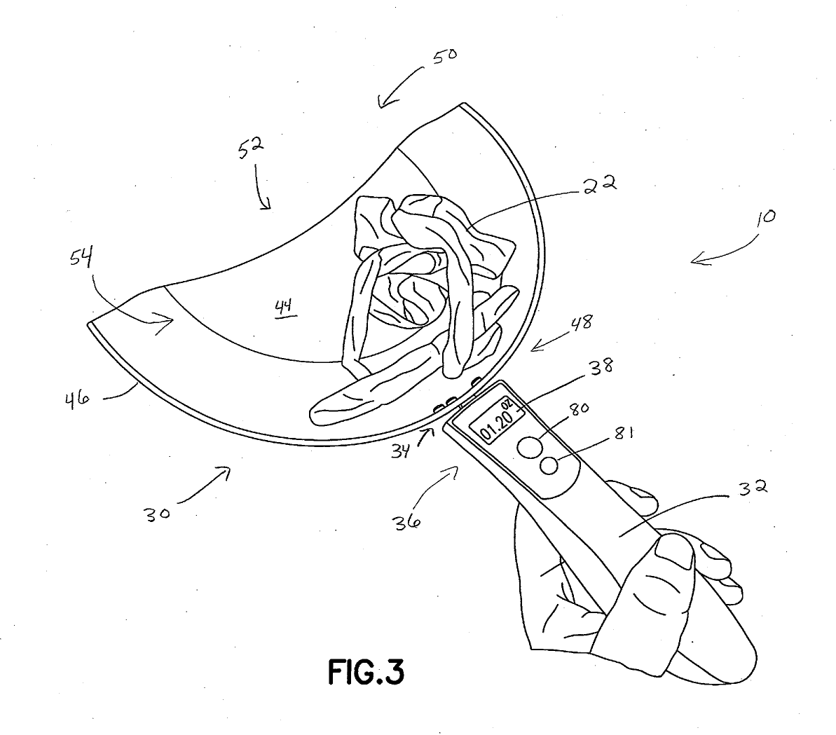

For example, referring to FIGS. 2 and 3, with the pan 10 contacting the vertical rotisserie 20, a cutting element, such as a sharp knife, may be used by a cook or food preparer to shave or carve a first amount of meat 22 (FIG. 3) from the vertical rotisserie 20 onto the pan 10. The pan 10 of the present disclosure simultaneously weighs the first amount of meat 22 as it is being collected onto the pan 10. In this manner, the cook or food preparer knows how much meat 22 has been collected instantaneously and without having to remove the pan 10 from contact with the vertical rotisserie 20.

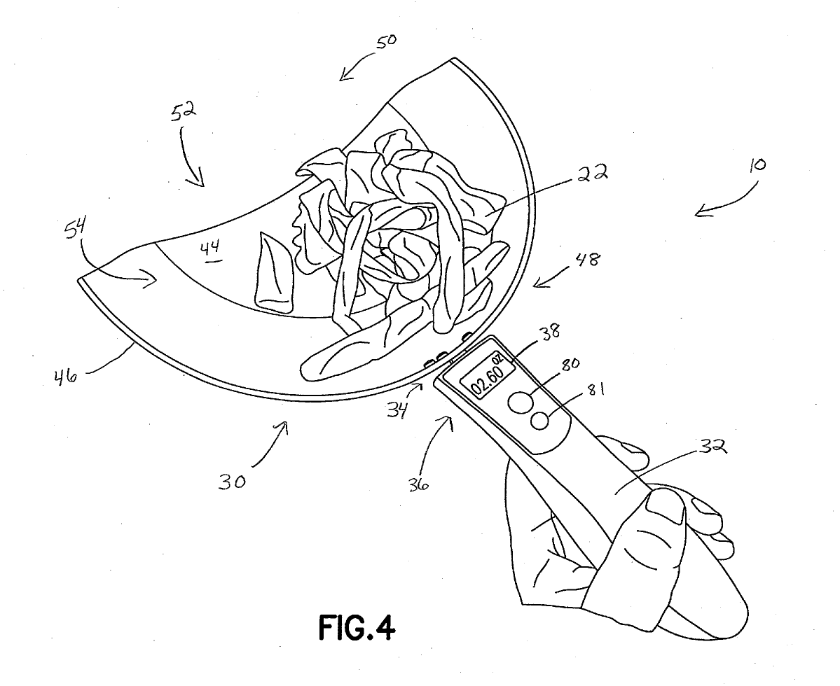

If the first amount of meat 22 is not sufficient for a meal being prepared, the cook or food preparer, with the pan still in contact with the vertical rotisserie 20, can easily and quickly use the cutting element to shave or carve a second amount of meat 22 (FIG. 4) from the vertical rotisserie 20 onto the pan 10. The pan 10 of the present disclosure again simultaneously weighs the second amount of meat 22 as it is being collected onto the pan 10. In this manner, the cook or food preparer knows how much meat 22 has been collected instantaneously and without having to remove the pan 10 from contact with the vertical rotisserie 20. The pan 10 of the present disclosure provides instantaneous feedback to a cook or food preparer of when the desired amount of the meat 22 is collected onto the pan 10.

Referring to FIGS. 15-16, use of a pan 10 of the present disclosure in accordance with another exemplary embodiment will now be described. In another embodiment, a pan 10 of the present disclosure is compatible with a container 100 holding a cooking ingredient 102. For example, referring to FIG. 15, a pan 10 may be positioned within a container 100 for scooping out a portion of a cooking ingredient 102 onto the pan 10.

The pan 10 of the present disclosure includes a weight measurement device 36 as described above. Advantageously, the pan 10 of the present disclosure allows a cook or food preparer to, simultaneously, scoop out a portion of a cooking ingredient 102 from the container 100 while weighing the amount of cooking ingredient 102 collected in the pan 10. A pan 10 of the present disclosure allows a scooping step and a weighing step to be completed simultaneously, thereby saving significant time and providing an easier process for a cook to accomplish such tasks.

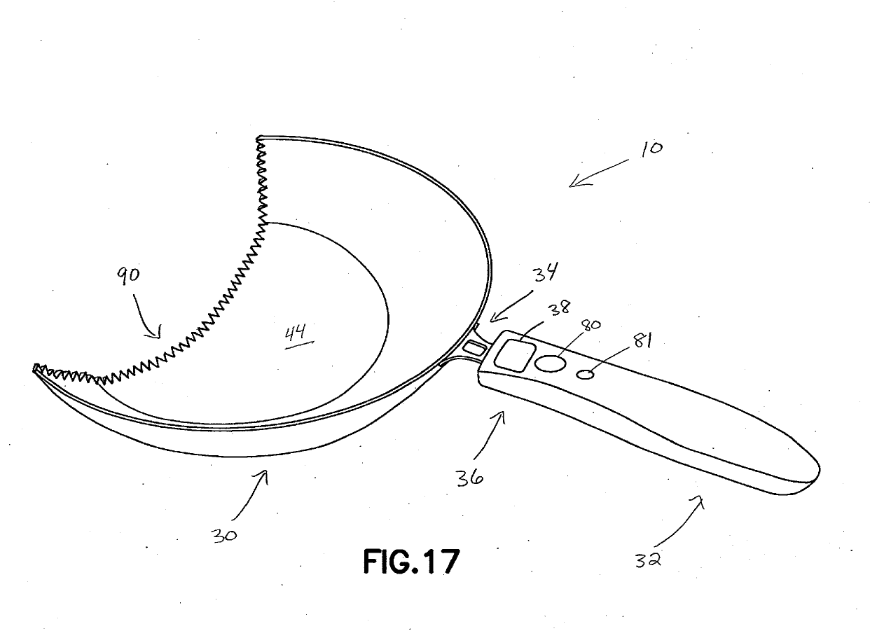

Referring to FIG. 17, in one embodiment, a pan 10 of the present disclosure may also include a ribbed surface 90. For example, in one embodiment, the second end 50 of the pan body 30 may include a ribbed surface 90. Advantageously, the ribbed surface 90 contacts and engages the meat 22 on the vertical rotisserie 20 to ensure that the pan 10 stays in contact with the vertical rotisserie 20 while a cook or food preparer shaves or carves meat 22 from the vertical rotisserie 20 onto the pan 10.

Referring to FIG. 17, in one embodiment, the ribbed surface 90 may comprise a plurality of triangular-shaped ribs. In other embodiments, the ribbed surface 90 may comprise other geometric shapes. For example, the ribbed surface 90 may comprise a plurality of rounded semicircular shapes.

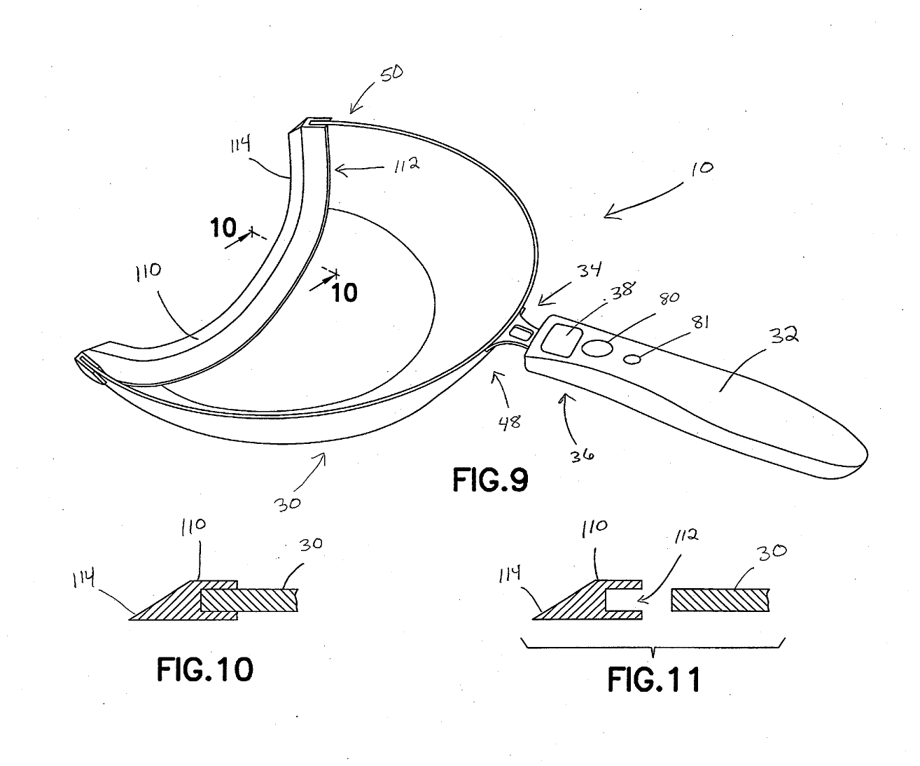

Referring to FIGS. 9-11, in one embodiment, a pan 10 of the present disclosure may also include a cutting element 110 removably attachable to the second end 50 of the pan body 30. In one embodiment, the cutting element 110 is attachable to the second end 50 of the pan body 30 using a securement portion 112. Securement portion 112 can be any type of securement mechanism known in the art to attach the cutting element 110 to the second end 50 of the pan body 30. In one embodiment, the cutting element 110 includes a cutting edge 114 for shaving or carving meat 22 from the vertical rotisserie 20.

In such an embodiment, the cutting element 110 is transitionable between an engaged position (FIGS. 9 and 10) in which the cutting element 110 is attached onto the second end 50 of the pan body 30 and a disengaged position (FIG. 11) in which the cutting element 110 is removed from the pan body 30. With the cutting element 110 attached onto the second end 50 of the pan body 30, the pan 10 can be used to shave or carve meat 22 from the vertical rotisserie 20 onto the pan 10.

In such an embodiment, no separate cutting element, such as a sharp knife, is needed. The pan 10 of the present disclosure can be used to carve the meat 22 and simultaneously weigh the meat 22 as it is being collected onto the pan 10. In this manner, a cook or food preparer can carve the meat 22 and simultaneously weigh the meat 22 as it is being collected onto the pan 10 using only one hand.

Furthermore, the cook or food preparer knows how much meat 22 has been collected instantaneously and without having to remove the pan 10 from contact with the vertical rotisserie 20. The pan 10 of the present disclosure provides instantaneous feedback to a cook or food preparer of when the desired amount of the meat 22 is collected onto the pan 10.

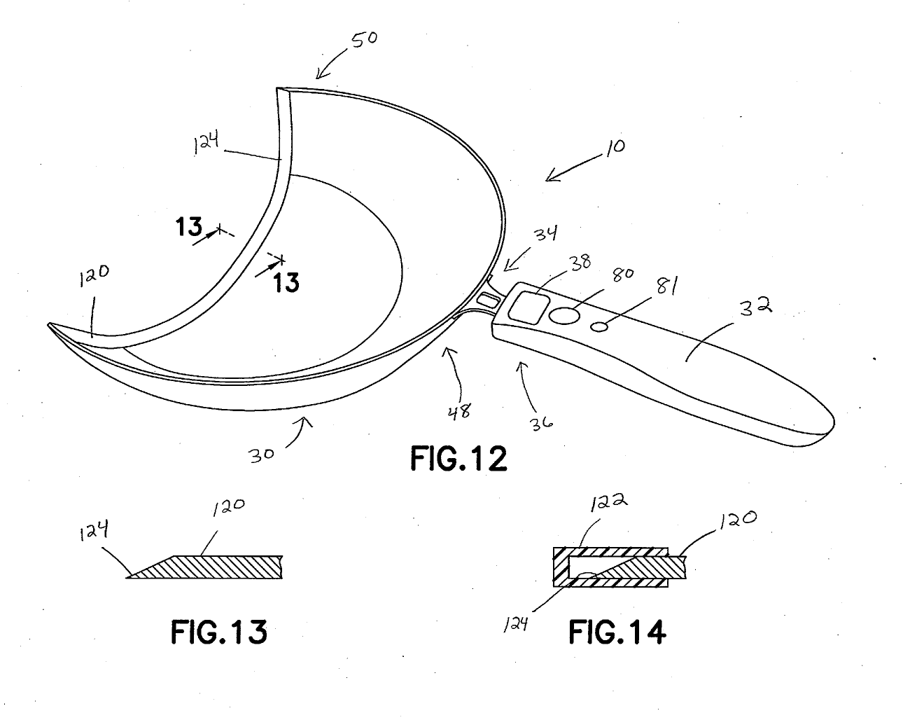

Referring to FIGS. 12-14, in one embodiment, a pan 10 of the present disclosure may also include a cutting element 120 that is integral to the second end 50 of the pan body 30. In one embodiment, the pan 10 may include a cover 122 for protectively shielding the cutting element 120 when the cutting element 120 is not being used. In one embodiment, the cutting element 120 includes a cutting edge 124 for shaving or carving meat 22 from the vertical rotisserie 20.

With the cutting element 120, the pan 10 can be used to shave or carve meat 22 from the vertical rotisserie 20 onto the pan 10. In such an embodiment, no separate cutting element, such as a sharp knife, is needed. The pan 10 of the present disclosure can be used to carve the meat 22 and simultaneously weigh the meat 22 as it is being collected onto the pan 10. In this manner, a cook or food preparer can carve the meat 22 and simultaneously weigh the meat 22 as it is being collected onto the pan 10 using only one hand.

Furthermore, the cook or food preparer knows how much meat 22 has been collected instantaneously and without having to remove the pan 10 from contact with the vertical rotisserie 20. The pan 10 of the present disclosure provides instantaneous feedback to a cook or food preparer of when the desired amount of the meat 22 is collected onto the pan 10.

Referring to FIG. 2, in one embodiment, a food preparation system 200 of the present disclosure includes a vertical rotisserie 20 and a pan 10.

In one embodiment, the vertical rotisserie 20 includes a foodstuff, e.g., a meat 22, thereon. The foodstuff, e.g., a meat 22, defines an exterior profile 24. In one embodiment, the pan 10 includes a pan body 30 having a semicircle portion 40 and a crescent portion 42. The pan body 30 includes a bottom 44, a sidewall 46 extending upwardly from a portion of the periphery of the bottom 44, a first end 48, and a second end 50, the second end 50 being open, the second end 50 defining a pan profile 52, and the pan profile 52 shaped to substantially correspond to the exterior profile 24. The pan 10 also includes a handle 32 extending outward from the first end 48, a weight measurement device 36 disposed within a portion of the handle 32, and a digital display 38 in communication with the weight measurement device 36, the digital display 38 located on a top portion or top surface 61 of the handle 32.

A pan 10 of the present disclosure is compatible with a vertical rotisserie 20. For example, referring to FIGS. 2-4, a pan 10 is positionable adjacent to and in contact with a vertical rotisserie 20 for shaving portions of meat 22 from the vertical rotisserie 20 onto the pan 10. The pan 10 of the present disclosure includes a weight measurement device 36. Advantageously, the pan 10 of the present disclosure allows a cook to, simultaneously, shave portions of meat 22 from the rotisserie 20 while weighing the amount of meat 22 collected in the pan 10. A pan 10 of the present disclosure allows a shaving step and a weighing step to be completed simultaneously, thereby saving significant time and providing an easier process for a cook to accomplish such tasks.

The pan 10 of the present disclosure is also compatible with other rotisseries. For example, the pan 10 of the present disclosure is compatible with horizontal rotisseries and vertical rotisseries.

A pan 10 of the present disclosure is also compatible with a container 100 holding a cooking ingredient 102. For example, referring to FIGS. 15-16, a pan 10 is positionable within a container 100 for scooping out a portion of a cooking ingredient 102 onto the pan 10. The pan 10 of the present disclosure includes a weight measurement device 36. Advantageously, the pan 10 of the present disclosure allows a cook to, simultaneously, scoop out a portion of a cooking ingredient 102 from the container 100 while weighing the amount of cooking ingredient 102 collected in the pan 10. A pan 10 of the present disclosure allows a scooping step and a weighing step to be completed simultaneously, thereby saving significant time and providing an easier process for a cook to accomplish such tasks.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A pan for a vertical rotisserie, comprising:
a pan body having a semicircle portion and a crescent portion, the pan body having a bottom, a sidewall extending upwardly from a portion of the periphery of the bottom, a first end, and a second end, the second end being open, and the second end defining a pan profile;
a handle extending outward from the first end;
a weight measurement device disposed within a portion of the handle; and
a digital display in communication with the weight measurement device, the digital display located on a top portion of the handle.

2. The pan of claim 1, wherein a portion of the second end of the pan body curves inward toward the first end.

3. The pan of claim 1, wherein the pan profile is shaped to substantially correspond to an exterior profile of the vertical rotisserie.

4. The pan of claim 1, wherein the second end of the pan body includes a ribbed surface.

5. The pan of claim 1, further comprising a connector having a first portion and a second portion, the first portion secured to the pan body and the second portion secured to the handle, wherein the first portion of the connector is secured to the pan body by three fasteners.

6. The pan of claim 1, wherein the weight measurement device includes a load sensor.

7. The pan of claim 1, wherein the weight measurement device includes a printed circuit board.

8. The pan of claim 1, wherein the weight measurement device is battery powered.

9. The pan of claim 1, wherein the digital display includes a liquid crystal display.

10. The pan of claim 1, wherein the pan includes a mode button selectable between a milliliter setting, a pound setting, a gram setting, and an ounce setting.

11. The pan of claim 1, wherein the handle includes a first handle portion and a second handle portion, the first handle portion including a plurality of alignment posts and the second handle portion including a plurality of receiving members, with the first handle portion secured to the second handle portion, the alignment posts are received within the respective receiving members, and with the first handle portion secured to the second handle portion, a cavity is defined within the handle and the weight measurement device is disposed within the cavity.

12. The pan of claim 1, further comprising a cutting element removably attachable to the second end of the pan body.

13. The pan of claim 1, wherein a portion of the second end of the pan body includes a cutting element.

14. The pan of claim 1, further comprising a gripping area on a portion of the handle.

15. A pan for a vertical rotisserie, comprising:
a pan body having a semicircle portion and a crescent portion, the pan body having a bottom, a sidewall extending upwardly from a portion of the periphery of the bottom, a first end, and a second end, the second end being open, the second end defining a pan profile, and the pan profile shaped to substantially correspond to an exterior profile of the vertical rotisserie;
a handle extending outward from the first end;
a connector having a first portion and a second portion, the first portion secured to the pan body and the second portion secured to the handle;
a weight measurement device disposed within a portion of the handle; and
a digital display in communication with the weight measurement device, the digital display located on a top portion of the handle,
wherein the pan includes a mode button selectable between a milliliter setting, a pound setting, a gram setting, and an ounce setting, and
wherein the handle includes a first handle portion and a second handle portion, the first handle portion including a plurality of alignment posts and the second handle portion including a plurality of receiving members, with the first handle portion secured to the second handle portion, the alignment posts are received within the respective receiving members, and with the first handle portion secured to the second handle portion, a cavity is defined within the handle and the weight measurement device is disposed within the cavity.

16. The pan of claim 15, further comprising a gripping area on a portion of the handle.

17. The pan of claim 15, wherein the weight measurement device includes a load sensor.

18. The pan of claim 15, further comprising a cutting element removably attachable to the second end of the pan body.

19. The pan of claim 15, wherein a portion of the second end of the pan body includes a cutting element.

20. A food preparation system, comprising:
a vertical rotisserie having a foodstuff thereon, the foodstuff defining an exterior profile; and
a pan, comprising:
a pan body having a semicircle portion and a crescent portion, the pan body having a bottom, a sidewall extending upwardly from a portion of the periphery of the bottom, a first end, and a second end, the second end being open, the second end defining a pan profile, and the pan profile shaped to substantially correspond to the exterior profile;
a handle extending outward from the first end;
a weight measurement device disposed within a portion of the handle; and
a digital display in communication with the weight measurement device, the digital display located on a top portion of the handle.
